(19) United States
(12) Patent Application Publication
(10) Pub. No.: US 2018/0077922 A1
(43) Pub. Date: Mar. 22, 2018

(54) TRANSDUCED CELL CRYOFORMULATION

(71) Applicants: Glaxosmithkline Intellectual Property Development, Brentford (GB); Ospedale San Raffaele S.r.l., Milan (IT); Fondazione Telethon, Rome (IT)

(72) Inventors: Christina BASFORD, Stevenage (GB); Alessandra BIFFI, Milan (IT); Giuliana FERRARI, Milan (IT); Natalie Anne FRANCIS, Stevenage (GB); Aileen Margaret KIRKPATRICK, Stevenage (GB)

(21) Appl. No.: 15/695,120

(22) Filed: Sep. 5, 2017

(30) Foreign Application Priority Data
Sep. 6, 2016 (GB) GB 1615068.2

(51) Int. Cl. A01N 1/02

(52) U.S. Cl. CPC A01N 1/0221; A01N 1/0226

(57) ABSTRACT

The invention relates to compositions for the cryopreservation of transduced haematopoietic cells, in particular transduced haematopoietic stem cells. The invention also relates to methods of preserving the viability of transduced haematopoietic cells using said compositions.

### CROSS REFERENCE TO RELATED APPLICATIONS

This application claims the benefit of U.K. Provisional Application No. GB 1615068.2, filed 6 Sep. 2016.

### FIELD OF THE INVENTION

The invention relates to methods and formulations for the cryopreservation of transduced haematopoietic cells, in particular transduced haematopoietic stem cells, which may be used in methods of gene therapy.

### BACKGROUND TO THE INVENTION

Cryopreservation involves freezing the cells at extremely low temperatures (typically −80° C. in a mechanical freezer or −196° C. in liquid- or vapour-phase nitrogen) and can give a shelf life of months to years. However, freezing can result in damage to the cells through several mechanisms. During freezing, water is removed from the cytoplasm of the cell as ice forms outside the cell. This increases the concentration of solutes within the cell through hyper-osmosis which can lead to dehydration and pH changes which may be damaging to the cell (Motta et al., (2014) Cryobiology, 68, (3) 343-348). This can also result in cell volume changes which can cause mechanical damage to the cells (Xu et al., (2014) Cryobiology, 68, (2) 294-302). Formation of ice crystals during freezing, or re-crystallisation during thawing, can also cause mechanical damage to the cell through pressure or puncture of the cell membrane. Low temperatures may alter the physical-chemical structure of cell membranes e.g. lipid complexes are denatured. There are two main types of cryoprotectant used to minimise freezing-related damage to cells: intracellular cryoprotectants penetrate the cell membrane, and work to prevent intracellular ice crystal formation and membrane rupture; while extracellular cryoprotectants cannot penetrate the cell membrane unless helped by an additional reagent, and work by lowering the hyperosmotic effect (Motta et al., (2014) Cryobiology, 68, (3) 343-348).

Human serum albumin (HSA) is the most abundant circulating protein in the plasma, which transports hormones, fatty acids, and other compounds, buffers pH, and maintains oncotic pressure. HSA has also been found to have antioxidant properties due to its ability to trap free-radicals (Roche et al., (2008) FEBS Lett 582, (13) 1783-1787).

The current manufacturing process for gene therapy products allows a shelf life for the transduced haematopoietic stem cells (HSCs) of 6 hours after formulation of the drug product (DP). This shelf-life is acceptable in the current manufacturing process, where the manufacturing organisation and hospital are co-located, but is likely to prove problematic when longer transport between the manufacturing organisation and the patient is required. In addition, this method requires real-time two-stage release of the drug product, with subsequent test results recorded after infusion. It is therefore an object of the present invention to provide ways of extending the shelf life of cell products which are used in methods of gene therapy.

### SUMMARY OF THE INVENTION

According to a first aspect of the invention, there is provided a composition comprising a transduced haematopoietic cell in a cryoprotective formulation, wherein the cryoprotective formulation comprises about 5% by volume of dimethyl sulfoxide (DMSO) and about 7% weight by volume of human serum albumin (HSA).

According to a further aspect of the invention, there is provided a method for preserving the viability of transduced haematopoietic cells, the method comprising:

(a) obtaining a plurality of transduced haematopoietic cells;

(b) suspending the transduced haematopoietic cells in a cryoprotective medium comprising about 5% by volume of dimethyl sulfoxide (DMSO) and about 7% weight by volume of human serum albumin (HSA), to form a suspension; and

(c) freezing the suspension.

According to a further aspect of the invention, there is provided a frozen suspension obtained by the method described herein.

According to a further aspect of the invention, there is provided a thawed suspension obtained by the method described herein.

### BRIEF DESCRIPTION OF THE FIGURES

FIG. 1: Comparison of 5% and 10% DMSO for cryopreservation of transduced CD34⁺ cells.

FIG. 2: Viability (2A, 2B) and recovery (2C, 2D) of cells held in 5% DMSO/7% HSA in saline for up to 4 hours at room temperature (2A, 2C) and at 4° C. (2B, 2D), both immediately after exposure and after 24 hours of normal cell culture.

FIG. 3: Results of immunophenotype analysis showing percentage of CD34+(3A, 3B) and CD34+/CD38− (3C, 3D) in cells held in 5% DMSO/7% HSA in saline for up to 4 hours at room temperature (3A, 3C) and at 4° C. (3B, 3D), both immediately after exposure and after 24 hours of normal cell culture.

FIG. 4: Results of CFU assay showing clonogenic potential of cells held in 5% DMSO/7% HSA in saline for up to 4 hours at room temperature (4A) or at 4° C. (4B), both immediately after exposure and after 24 hours of normal cell culture. Results are expressed as a change in clonogenic potential from TO (ΔCFU).

FIG. 5: Viability (5A, 5B) and recovery (5C, 5D) of cells held in 5% DMSO/7% HSA in saline for up to 4 hours at room temperature (5A, 5C) or 4° C. (5B, 5D). Samples were measured pre-freeze, immediately after exposure and after 24 hours of normal cell culture.

FIG. 6: Results of immunophenotype for analysis of CD34 and CD38 expression for cells held in 5% DMSO/7% HSA in saline for up to 4 hours at room temperature (6A, 6C) or 4° C. (6B, 6D), pre-freeze (triangle), immediately after exposure (circle) and after 24 hours of normal cell culture (square).

FIG. 7: Results of colony forming unit assay for cells held in 5% DMSO/7% HSA in saline for up to 4 hours at room temperature (7A) or 4° C. (7B), pre-freeze (triangle), immediately after exposure (circle) and after 24 hours of normal cell culture (square).

FIG. 8: Cell count was assessed for up to 6 months, at 2 sites, in CD34+ cells derived from mobilised peripheral blood at concentrations of 2 and 10 million cells per ml. No significant decrease was observed in the number of viable cells recovered after cryopreservation for up to 6 months.

FIG. 9: Cell viability was assessed for up to 6 months, at 2 sites, in CD34+ cells derived from mobilised peripheral blood at concentrations of 2 and 10 million cells per ml. No significant decrease was observed in the percentage viability after cryopreservation for up to 6 months.

FIG. 10: Immunophenotype was assessed by measuring CD34 expression for up to 6 months, at 2 sites, in cells derived from mobilised peripheral blood at concentrations of 2 and 10 million cells per ml. No significant decrease was observed in the percentage of CD34+ cells after cryopreservation for up to 6 months.

FIG. 11: Clonogenic potential was assessed for up to 6 months, at 2 sites, in CD34+ cells derived from mobilised peripheral blood at concentrations of 2 and 10 million cells per ml. No significant decrease was observed in the number of colonies formed after cryopreservation for up to 6 months.

FIG. 12: Vector copy number was assessed for up to 6 months, at 2 sites, in CD34+ cells derived from mobilised peripheral blood at concentrations of 2 and 10 million cells per ml. No significant decrease was observed in vector copy number after cryopreservation for up to 2 months.

FIG. 13: Transduction efficiency was assessed for up to 6 months, at 2 sites, in CD34+ cells derived from mobilised peripheral blood at concentrations of 2 and 10 million cells per ml. No significant decrease was observed in transduction ability after cryopreservation for up to 2 months.

FIG. 14: ARSA transgene activity was assessed for up to 6 months, at 2 sites, in CD34+ cells derived from mobilised peripheral blood at concentrations of 2 and 10 million cells per ml. No significant decrease was observed in transgene activity after cryopreservation for up to 2 months.

### DETAILED DESCRIPTION OF THE INVENTION

### Definitions

Unless defined otherwise, all technical and scientific terms used herein have the same meaning as is commonly understood by one of skill in the art (e.g., in cell culture, molecular genetics, nucleic acid chemistry, hybridization techniques and biochemistry). Standard techniques are used for molecular, genetic and biochemical methods (see generally, Sambrook et al., Molecular Cloning: A Laboratory Manual, 2^{nd} ed. (1989) Cold Spring Harbor Laboratory Press, Cold Spring Harbor, N.Y. and Ausubel et al., Short Protocols in Molecular Biology (1999) 4^{th} Ed, John Wiley & Sons, Inc. which are incorporated herein by reference in their entirety) and chemical methods. All patents and publications referred to herein are incorporated by reference in their entirety.

The term “comprising” encompasses “including” or “consisting” e.g. a composition “comprising” X may consist exclusively of X or may include something additional e.g. X+Y.

The term “consisting essentially of” limits the scope of the feature to the specified materials or steps and those that do not materially affect the basic characteristic(s) of the claimed feature.

The term “consisting of” excludes the presence of any additional component(s).

The term “about” as used herein when referring to a measurable value such as an amount, a temporal duration, and the like, is meant to encompass variations of ±20% or ±10%, including ±5%, ±1%, and ±0.1% from the specified value.

The term “haematopoietic cell” refers to blood cells, such as any of the kinds of cell normally found circulating in the blood. Examples of haematopoietic cells include red blood cells (e.g. erythrocytes) and white blood cells (e.g. T cells, B cells, and natural killer cells). For the avoidance of doubt, it will be understood that this term includes haematopoietic stem cells.

The term “haematopoietic stem cell” or “HSC” refers to stem cells that give rise to blood cells through the process of haematopoiesis. They are derived from mesoderm and located in the red bone marrow, which is contained in the core of most bones. HSCs give rise to both myeloid (i.e. monocytes, macrophages, neutrophils, basophils, eosinophils, erythrocytes, dendritic cells, and megakaryocytes or platelets) and lymphoid (i.e. T cells, B cells, and natural killer cells) lineages of blood cells.

The term “cryoprotective formulation” refers to a formulation or medium in which cells are suspended when frozen. In particular, the formulation is used to protect the cells/tissue from freezing damage. It will be understood that the term “cryoprotective formulation” can be used interchangeably with “cryoprotective medium”.

The term “Human Serum Albumin” or “HSA” refers to a type of serum albumin found in human blood. Albumin is an essential protein which: transports hormones, fatty acids, and other compounds in the blood by acting as a carrier protein; buffers pH; and maintains oncotic pressure.

The term “Dimethyl Sulfoxide” or “DMSO” refers to an organosulfur compound with the formula (CH₃)₂SO. It is commonly used as a polar aprotic solvent.

The term “vector” refers to a vehicle which is able to artificially carry foreign genetic material into another cell, where it can be replicated and/or expressed. Examples of vectors include plasmids and viral vectors, such as retroviral and lentiviral vectors, which are of particular interest in the present application. Lentiviral vectors, such as those based upon Human Immunodeficiency Virus Type 1 (HIV-1) are widely used as they are able to integrate into non-proliferating cells. Viral vectors can be made replication defective by splitting the viral genome into separate parts, e.g., by placing on separate plasmids. For example, the so-called first generation of lentiviral vectors, developed by the Salk Institute for Biological Studies, was built as a three-plasmid expression system consisting of a packaging expression cassette, the envelope expression cassette and the vector expression cassette. The “packaging plasmid” contains the entire gag-pol sequences, the regulatory (tat and rev) and the accessory (vif, vpr, vpu, net) sequences. The “envelope plasmid” holds the Vesicular stomatitis virus glycoprotein (VSVg) in substitution for the native HIV-1 envelope protein, under the control of a cytomegalovirus (CMV) promoter. The third plasmid (the “transfer plasmid”) carries the Long Terminal Repeats (LTRs), encapsulation sequence (ψ), the Rev Response Element (RRE) sequence and the CMV promoter to express the transgene inside the host cell.

The second lentiviral vector generation was characterized by the deletion of the virulence sequences vpr, vif, vpu and nef. The packaging vector was reduced to gag, pol, tat and rev genes, therefore increasing the safety of the system.

To improve the lentiviral system, the third-generation vectors have been designed by removing the tat gene from the packaging construct and inactivating the LTR from the vector cassette, therefore reducing problems related to insertional mutagenesis effects.

The various lentivirus generations are described in the following references: First generation: Naldini et al. (1996) Science 272(5259): 263-7; Second generation: Zufferey et al. (1997) Nat. Biotechnol. 15(9): 871-5; Third generation: Dull et al. (1998) J. Virol. 72(11): 8463-7, all of which are incorporated herein by reference in their entirety. A review on the development of lentiviral vectors can be found in Sakuma et al. (2012) Biochem. J. 443(3): 603-18 and Picanco-Castro et al. (2008) Exp. Opin. Therap. Patents 18(5):525-539.

The terms “transfection”, “transformation” and “transduction” as used herein, may be used to describe the insertion of the vector into the target cell. Insertion of a vector is usually called transformation for bacterial cells and transfection for eukaryotic cells, although insertion of a viral vector may also be called transduction.

The term “transgene” refers to heterologous or foreign DNA which is not present or not sufficiently expressed in the host cell (i.e. the haematopoietic cell) in which it is introduced. This may include, for example, when a target gene is not expressed correctly in the host cell, therefore a corrected version of the target gene is introduced as the transgene. Therefore, the transgene may be a gene of potential therapeutic interest. The transgene may have been obtained from another cell type, or another species, or prepared synthetically. Alternatively, the transgene may have been obtained from the host cell, but operably linked to regulatory regions which are different to those present in the native gene. Alternatively, the transgene may be a different allele or variant of a gene present in the host cell.

The term “autologous” as used herein, refers to cells from the same subject. The term “allogeneic” as used herein, refers to cells of the same species that differ genetically to the cell in comparison.

The terms “individual”, “subject” and “patient” are used herein interchangeably. In one embodiment, the subject is a mammal, such as a mouse, a primate, for example a marmoset or monkey, or a human. In a further embodiment, the subject is a human.

### Cryoformulations

According to a first aspect of the invention, there is provided a composition comprising a transduced haematopoietic cell in a cryoprotective formulation, wherein the cryoprotective formulation comprises about 5% by volume of dimethyl sulfoxide (DMSO) and about 7% weight by volume of human serum albumin (HSA).

DMSO is a low molecular weight, cell-permeable cryoprotectant that is routinely used for cryopreservation of bone marrow, cord blood and other blood products intended for transplantation. However, the use of DMSO in cryopreserved stem cell transplants is associated with adverse effects following infusion which are more commonly mild symptoms e.g. fever, chills and a garlic odour, but occasionally more severe (Pereira-Cunha et al., (2015) Vox Sang., 108, (1) 72-81). For this reason, ways of reducing the DMSO concentration, or replacing it altogether, is of great interest.

In one embodiment, the cryoprotective formulation comprises 3% to 7%, such as 4% to 6%, 4% to 5% or 5% to 6% volume by volume (v/v) of DMSO. In a further embodiment, the cryoprotective formulation comprises 5% volume by volume of DMSO.

In one embodiment, the cryoprotective formulation comprises 5% to 9%, such as 6% to 8%, 6% to 7% or 7% to 8% weight by volume (w/v) of HSA. In a further embodiment, the cryoprotective formulation comprises 7% weight by volume of HSA.

The cryoprotective formulation may contain auxiliary substances, such as water, saline, pH buffering agents, carriers or excipients, other stabilizers and/or buffers or other reagents that enhance the viability of the haematopoietic cells following the freezing and thawing process.

In one embodiment, the cryoprotective formulation is formulated in saline solution. In a further embodiment, the cryoprotective formulation is formulated in 0.9% w/v saline solution. Saline solution is suitable for administration to patients, therefore the advantage of formulating the formulation in saline solution is that it allows direct infusion into patients.

In one embodiment, the haematopoietic cell is a white blood cell, such as a lymphocyte. In a further embodiment, the haematopoietic cell is a lymphocyte, such as a B cell, T cell or Natural Killer cell. In a yet further embodiment, the haematopoietic cell is a T cell or Natural Killer cell.

In one embodiment, the haematopoietic cell is a human haematopoietic cell.

In one embodiment, the haematopoietic cell is a haematopoietic stem cell. In a further embodiment, the haematopoietic stem cell is a CD34+ haematopoietic stem cell or a CD34+CD38− haematopoietic stem cell. In a yet further embodiment, the haematopoietic stem cell is a CD34+ haematopoietic stem cell.

In one embodiment, the haematopoietic cell is allogeneic or autologous. It will be understood that “autologous” refers to cells obtained from the patient themselves, whereas “allogeneic” refers to cells obtained from a donor. In order to prevent the allogeneic cells from being rejected by the patient, they would either need to be derived from a compatible donor or modified to ensure no antigens are present on the cell surface which would initiate an unwanted immune response.

In one embodiment, the haematopoietic cell is obtained from bone marrow, mobilised peripheral blood or cord blood. In a further embodiment, the haematopoietic cell is obtained from bone marrow.

In one embodiment, the haematopoietic cell is transduced with a viral vector. In a further embodiment, the haematopoietic cell is transduced with a retroviral vector.

In one embodiment, the retroviral vector is derived from, or selected from, a lentivirus, alpha-retrovirus, gamma-retrovirus or foamy-retrovirus, such as a lentivirus or gamma-retrovirus, in particular a lentivirus. In a further embodiment, the retroviral vector particle is a lentivirus selected from the group consisting of HIV-1, HIV-2, SIV, FIV, EIAV and Visna. Lentiviruses are able to infect non-dividing (i.e. quiescent) cells which makes them attractive vectors for gene therapy. In a yet further embodiment, the retroviral vector is HIV-1 or is derived from HIV-1. The genomic structure of some retroviruses may be found in the art. For example, details on HIV-1 may be found from the NCBI Genbank (Genome Accession No. AF033819). HIV-1 is one of the best understood retroviruses and is therefore often used as a viral vector.

In one embodiment, the viral vector comprises a transgene (i.e. a heterologous nucleic acid coding sequence). This transgene may be a therapeutically active gene which encodes a gene product which may be used to treat or ameliorate a target disease. Therefore, in one embodiment, the transgene encodes a therapeutic gene. The transgene may encode, for example, a protein (for example an enzyme), an antisense RNA, a ribozyme, a toxin, an antigen (which may be used to induce antibodies or helper T-cells or cytotoxic T-cells) or an antibody (such as a single chain antibody).

In a one embodiment, the transgene encodes a protein. In a further embodiment, the transgene encodes adenosine deaminase (ADA), arylsulfatase A (ARSA), Wiskott-Aldrich syndrome protein (WASp), phagocyte NADPH oxidase, galactosylceramidase, haemoglobin, or alpha-L-iduronidase, or functional fragments or derivatives thereof. In a yet further embodiment, the transgene encodes a protein selected from the group consisting of: adenosine deaminase (ADA), arylsulfatase A (ARSA), Wiskott-Aldrich syndrome protein (WASp), phagocyte NADPH oxidase, galactosylceramidase, haemoglobin and alpha-L-iduronidase.

The aim of gene therapy is to modify the genetic material of living cells for therapeutic purposes, and it involves the insertion of a functional gene into a cell to achieve a therapeutic effect. For example, haematopoietic stem cell (HSCs) may be extracted from the patient and purified by selecting for CD34 expressing cells (CD34+). Those cells can be cultured with cytokines and growth factors, and then transfected with a viral vector containing the transgene encoding the normally functioning protein, and then given back to the patient. These cells take root in the person's bone marrow, replicating and creating cells that mature and create normally functioning protein, thereby resolving the problem.

Therefore, in one embodiment, the transduced haematopoietic cells described herein may be used in ex vivo gene therapy. The term “ex vivo gene therapy” refers to the in vitro transduction (e.g. by retroviral transduction) of cells to form transduced cells prior to introducing them into a patient. Therefore, the transduced haematopoietic cells described herein may be used in methods of gene therapy because they contain the corrected gene. In particular, the transduced haematopoietic stem cells described herein are useful in methods of gene therapy because all progeny from the stem cells will contain the corrected gene. The transduced haematopoietic cells can therefore be used for treatment of a mammalian subject, such as a human subject, suffering from a condition including but not limited to, inherited disorders, cancer, and certain viral infections.

Adenosine deaminase deficiency (also called ADA deficiency or ADA-SCID) is a metabolic disorder that causes immunodeficiency due to a lack of the enzyme adenosine deaminase (ADA). Therefore, it will be understood that if the haematopoietic cell is transduced with the viral vector containing a transgene encoding adenosine deaminase, then this transduced cell may be used in the treatment of ADA-SCID. Therefore, in one embodiment, the transduced haematopoietic cell contains a transgene encoding adenosine deaminase or a fragment or derivative thereof. In a further embodiment, the transduced haematopoietic cell is for use in the treatment of ADA-SCID. In a yet further embodiment, the transduced haematopoietic cell is Strimvelis™ (autologous CD34+ enriched cell fraction that contains CD34+ cells transduced with retroviral vector that encodes for the human ADA cDNA sequence).

Metachromatic leukodystrophy (also called MLD or Arylsulfatase A deficiency) is a lysosomal storage disease caused by a deficiency of the enzyme arylsulfatase A (ARSA). Therefore, it will be understood that if the haematopoietic cell is transduced with the viral vector containing a transgene encoding arylsulfatase A, then this transduced cell may be used in the treatment of MLD. Therefore, in one embodiment, the transduced haematopoietic cell contains a transgene encoding arylsulfatase A or a fragment or derivative thereof. In a further embodiment, the transduced haematopoietic cell contains the ARSA gene. In a further embodiment, the transduced haematopoietic cell is for use in the treatment of MLD.

Wiskott-Aldrich syndrome (also called WAS or eczema-thrombocytopenia-immunodeficiency syndrome) is a X-linked recessive disease caused by mutations in the WASp gene. Therefore, it will be understood that if the haematopoietic cell is transduced with the viral vector containing a transgene encoding a functional WASp gene, then this transduced cell may be used in the treatment of WAS. Therefore, in one embodiment, the transduced haematopoietic cell contains a transgene encoding Wiskott-Aldrich syndrome protein (WASp) or a fragment or derivative thereof. In a further embodiment, the transduced haematopoietic cell contains the WASp gene. In a further embodiment, the transduced haematopoietic cell is for use in the treatment of WAS.

Chronic granulomatous disease (also called CGD) is caused by mutations in any one of five different genes which leads to a defect in an enzyme called phagocyte NADPH oxidase. Certain white blood cells use this enzyme to produce hydrogen peroxide, which these cells need in order to kill certain bacteria and fungi. Therefore, it will be understood that if the haematopoietic cell is transduced with the viral vector containing a transgene encoding phagocyte NADPH oxidase, then this transduced cell may be used in the treatment of CGD. Therefore, in one embodiment, the transduced haematopoietic cell contains a transgene encoding phagocyte NADPH oxidase or a fragment or derivative thereof. In a further embodiment, the transduced haematopoietic cell is for use in the treatment of CGD.

Globoid cell leukodystrophy (also called GCL, galactosylceramide lipidosis or Krabbe disease) is caused by mutations in the GALC gene which causes a deficiency of an enzyme called galactosylceramidase. This affects the growth of the nerve's protective myelin sheath and causes severe degeneration of motor skills. Therefore, it will be understood that if the haematopoietic cell is transduced with the viral vector containing a transgene encoding galactosylceramidase, then this transduced cell may be used in the treatment of GCL. Therefore, in one embodiment, the transduced haematopoietic cell contains a transgene encoding galactosylceramidase or a fragment or derivative thereof. In a further embodiment, the transduced haematopoietic cell contains the GALC gene. In a further embodiment, the transduced haematopoietic cell is for use in the treatment of GCL.

Beta Thalassemia (also called Beta Thal) is an inherited blood disorder characterized by reduced levels of functional haemoglobin caused by a mutation in the HBB gene. Therefore, it will be understood that if the haematopoietic cell is transduced with the viral vector containing a transgene encoding functional haemoglobin, then this transduced cell may be used in the treatment of Beta Thalassemia. Therefore, in one embodiment, the transduced haematopoietic cell contains a transgene encoding functional haemoglobin or a fragment or derivative thereof. In a further embodiment, the transduced haematopoietic cell contains the HBB gene. In a further embodiment, the transduced haematopoietic cell is for use in the treatment of Beta Thalassemia.

Mucopolysaccharidosis Type I (also called MPS Type I) is a form of MPS (i.e. an inability to metabolize complex carbohydrates known as mucopolysaccharides into simpler molecules) caused by a deficiency of the enzyme alpha-L-iduronidase. Therefore, it will be understood that if the haematopoietic cell is transduced with the viral vector containing a transgene encoding alpha-L-iduronidase, then this transduced cell may be used in the treatment of MPS Type I. Therefore, in one embodiment, the transduced haematopoietic cell contains a transgene encoding alpha-L-iduronidase or a fragment or derivative thereof. In a further embodiment, the transduced haematopoietic cell is for use in the treatment of MPS Type I.

### Methods

According to a further aspect of the invention, there is provided a method for preserving the viability of transduced haematopoietic cells, the method comprising:

(a) obtaining a plurality of transduced haematopoietic cells;

(b) suspending the transduced haematopoietic cells in a cryoprotective medium comprising about 5% by volume of dimethyl sulfoxide (DMSO) and about 7% weight by volume of human serum albumin (HSA), to form a suspension; and

(c) freezing the suspension.

In one embodiment, the viability of the transduced haematopoietic cells is maintained for at least 2 months, such as at least 4 months, in particular at least 6 months.

In one embodiment, step (a) comprises: (i) obtaining a plurality of haematopoietic cells; and (ii) transducing the haematopoietic cells with a viral vector. In one embodiment, the haematopoietic cells are obtained from a patient (i.e. autologous) or a donor (i.e. allogeneic). In a further embodiment, the haematopoietic cells are obtained from a patient (i.e. autologous). The transducing methods of step (ii) may be performed by methods well known in the art.

There are many standard methods known in the art which can be used to freeze the cells, e.g. immersing containers holding the suspension of step (b) in a solid carbon dioxide and alcohol mixture, or in liquid nitrogen, or placed directly in a freezer set at a desired temperature. In one embodiment, the suspension (i.e. obtained in step (b)) is frozen in step (c) with a programmed freezer (i.e. controlled rate freezer). Controlled rate freezers are commercially available and well known in the art, for example the EF600M controlled rate freezer (Aysmptote). Such controlled rate freezers can be used to both freeze and thaw a suspension.

In one embodiment, the suspension is frozen in step (c) at a temperature from about −200° C. to a temperature of about −35° C. In a further embodiment, the suspension is frozen in step (c) at a temperature of about −80° C.

In one embodiment, the transduced haematopoietic cells are frozen at a cell concentration of at least about 1×10⁶/ml, such as at least 2×10⁶/ml, 5×10⁶/ml or 10×10⁶/ml (i.e. 1×10⁷/ml). In a further embodiment, the transduced haematopoietic cells are frozen at a cell concentration of about 1×10⁶/ml, 2×10⁶/ml or 1×10⁷/ml.

In one embodiment, the method additionally comprises: (d) thawing the frozen suspension. There are many standard methods known in the art which can be used to thaw the frozen suspension, e.g. by allowing the suspension to thaw slowly at room temperature, or by immersing the frozen suspension in a liquid, e.g. a water-bath set at a temperature of about 37° C. Cells can also be thawed by mixing the suspension with a thawed medium. In one embodiment, the frozen suspension is thawed using a programmed freezer (e.g. a controlled rate freezer).

In one embodiment, the method additionally comprises: (e) administering the thawed suspension to a patient. In one embodiment, the thawed suspension is washed prior to the administering step. In one embodiment, the thawed suspension is administered to the patient in an effective amount, i.e. an amount sufficient to induce or reduce the desired phenotype. Effective doses and treatment regimes for administering the composition of the present invention may be dependent on factors such as the age, weight and health status of the patient and disease to be treated. Such factors are within the purview of the attending physician.

In one embodiment, the patient is a human. In a further embodiment, the human may be at any stage of development at the time of administration, e.g. infantile, juvenile or adult.

According to a further aspect of the invention, there is provided a frozen suspension obtained by the method described herein.

According to a further aspect of the invention, there is provided a thawed suspension obtained by the method described herein.

The invention will now be described in more detail with reference to the following non-limiting examples.

### Example 1: In Vitro Evaluation of Cell Preservation Reagents for Lentiviral Vector-Transduced CD34⁺ Cells

Fresh CD34⁺ cells were purified from 3 different healthy bone marrow donors using cliniMACS plus device, according to the manufacturer's instructions. Transduction with a lentiviral vector containing the ARSA gene was carried out (using methods well known in the art). Cells were frozen using the EF600M controlled rate freezer (Aysmptote) at a cell concentration of 1×10⁶/ml, using the programme shown in Table 1, using a formulation comprised of dimethyl sulfoxide (DMSO) at the specified concentration (either 5% or 10% v/v) with 7% w/v human serum albumin (HSA) in 0.9% w/v saline solution.

TABLE 1
Controlled rate freezing programme used on the Asymptote EF600M
in process development experiments

| Stage | End Temp (° C.) | Time (hh:mm:ss) | Slope (° C./min) |
|---|---|---|---|
| 0 | 4 | — | — |
| 1 | −7 | 00:05:30 | −2 |
| 2 | −7 | 00:10:00 | 0 (hold) |
| 3 | −40 | 00:33:00 | −1 |
| 4 | −80 | 00:13:33 | −3 |

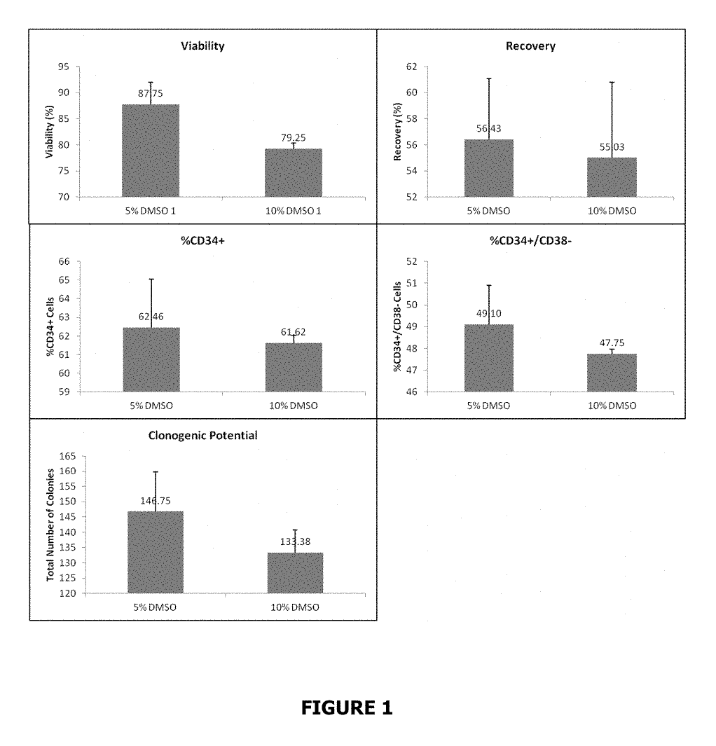

A preliminary experiment (FIG. 1) compared a formulation of 5% DMSO to 10% DMSO, and demonstrated significantly higher viability (p=0.0086) in samples cryopreserved in 5% DMSO. There was no significant difference in recovery, % CD34+ cells, % CD34+CD38− cells, or clonogenic potential between the two conditions.

### Example 2: Assessment of DMSO Toxicity

DMSO is a commonly used cryopreservant in haematopoietic stem cell transplantation (HSCT) from several different sources, including bone marrow, mobilised peripheral blood and cord blood. However, there have been suggestions that DMSO may have a toxic effect to the cells: an early paper found that clonogenic potential was reduced in cells exposed to DMSO (Douay et al., (1982) C. R. Seances Acad. Sci. III, 294, (2) 103-106); although subsequent papers have shown no loss of viability or clonogenic potential for up to 2 hours (Rowley & Anderson, (1993) Bone Marrow Transplant., 11, (5) 389-393; Branch et al., (1994) Transfusion, 34, (10) 887-890; Katayama et al, 1997).

Studies were carried out to assess the toxicity of 5% DMSO to CD34+ cells for up to 4 hours, both before and after cryopreservation and thawing, at room temperature and 4° C. CD34+ cells were isolated from healthy donor bone marrow using density gradient separation and magnetic purification using midiMACS columns. Cells were formulated in 5% DMSO, 7% (weight by volume) HSA in saline, at a concentration of 1×10⁶ cells/ml in a 50 ml CryoMACS bag. Cells were held for 4 hours either before cryopreservation or after, at both room temperature and 4° C. Cryopreservation was carried out using the Asymptote EF600M controlled rate freezer, using the programme described in Table 1.

### 2.1 Pre-Freeze Stability

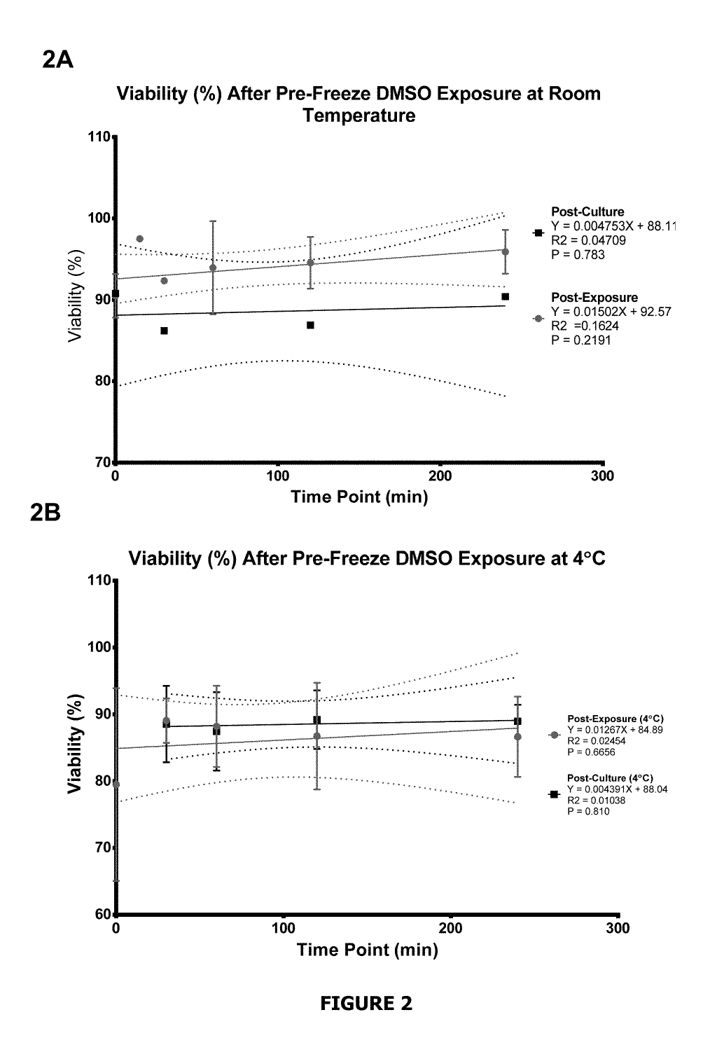

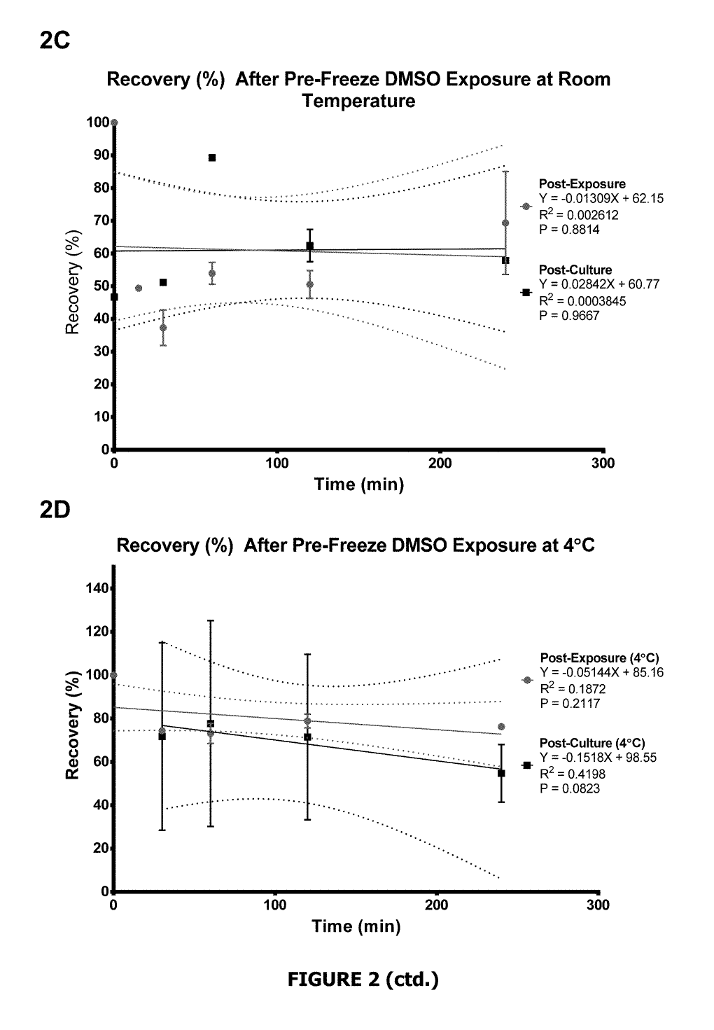

FIG. 2 shows that there is no significant loss of viability over the 4 hour hold time at either temperature, demonstrating no toxicity of 5% DMSO to the cells. There is also no significant difference in viability between post-exposure and post-culture samples. Viability remains above 80% at all time points. There is also no significant decrease in recovery over the 4 hour hold time at either temperature tested, demonstrating no loss of cells as a result of DMSO toxicity. There is also no significant difference in recovery between post-exposure and post-culture samples.

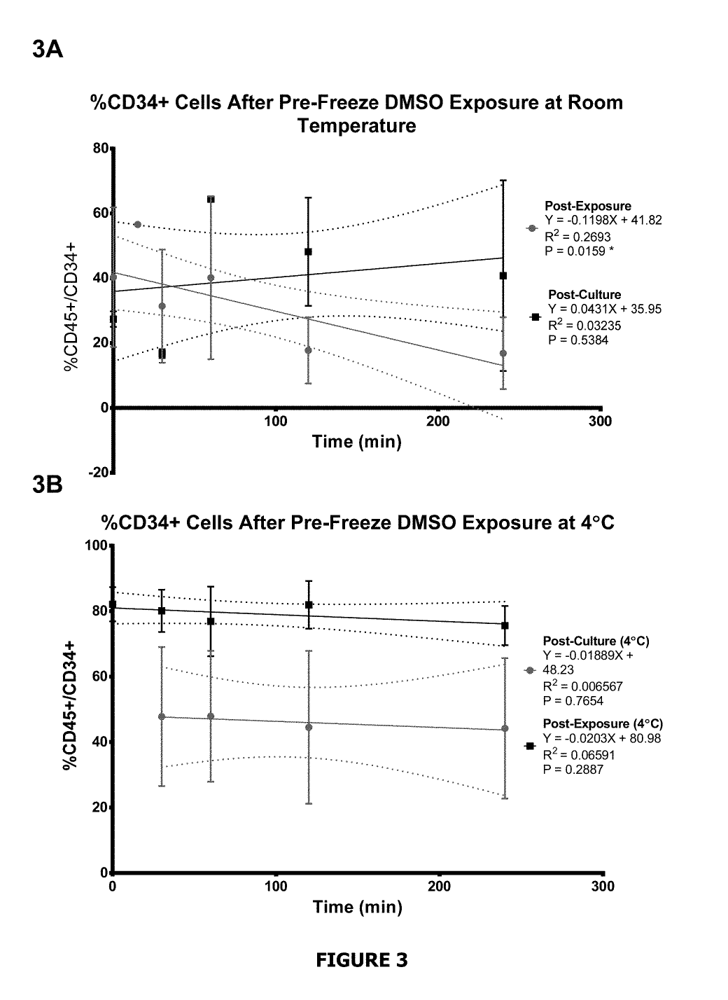

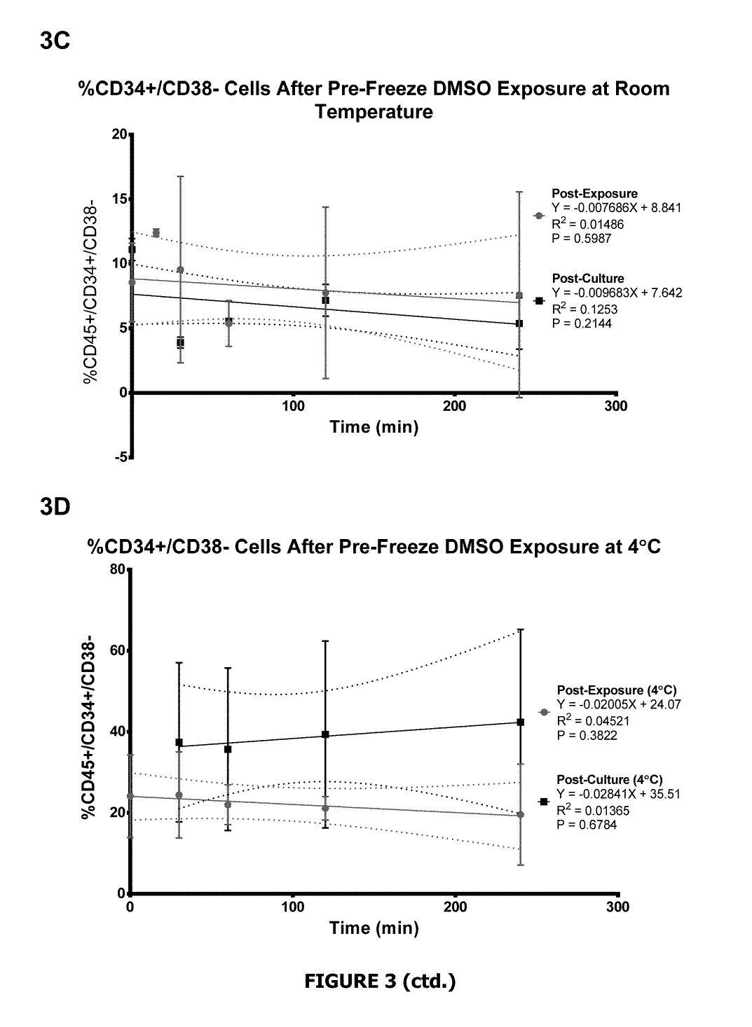

FIG. 3 shows that there is no significant decrease in the % CD34+ cells during 4 hours of 5% DMSO exposure at either temperature. There is also no significant difference between post-exposure and post-culture samples. Similarly, there is no significant decrease in % CD34+/CD38− cells over the 4 hour exposure period. However, following 24 hours of normal cell culture, the % CD34+/CD38− significantly increases compared to post-exposure samples (p=0.003) in samples held at 4° C., but not in those held at room temperature.

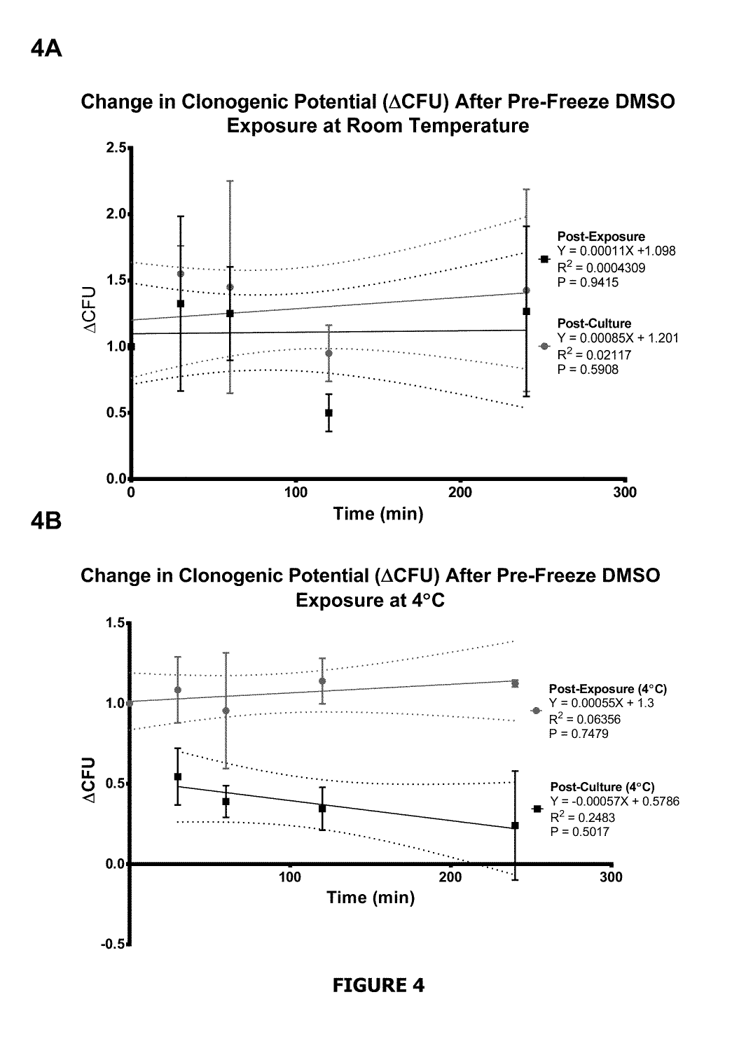

FIG. 4 shows that there is no significant decrease in clonogenic potential in CD34+ cells exposed to 5% DMSO for up to 4 hours, either immediately post-exposure or post-culture, for samples held at either temperature. The same results are demonstrated by the ΔCFU graph, which normalises the result to the TO measurement for each sample, therefore removing variability arising from the use of different bone marrow donors.

### 2.2 Post-Thaw Stability

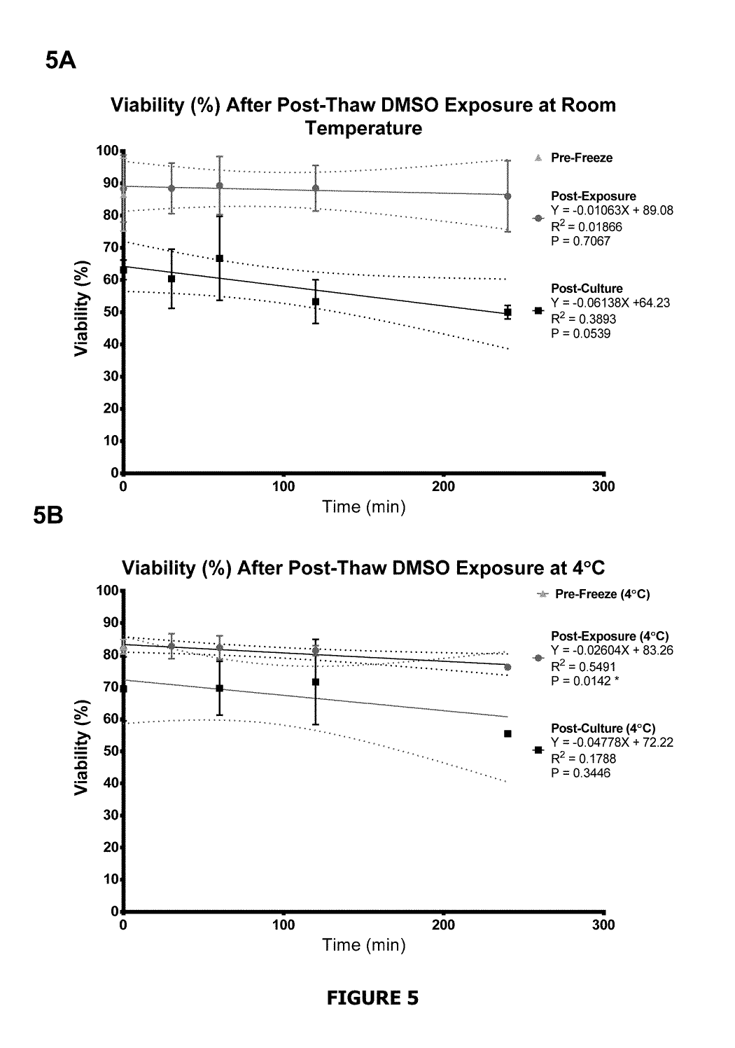

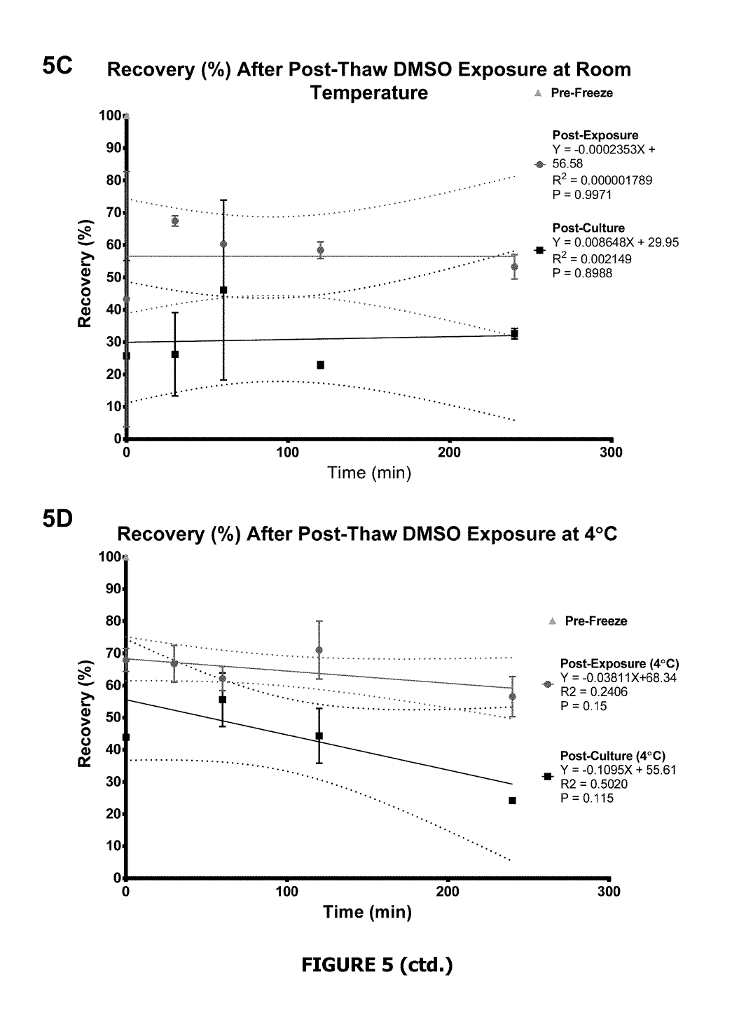

FIG. 5 shows that there is no significant loss of viability in CD34+ cells exposed to 5% DMSO for up to 4 hours for samples held at either 4° C. or room temperature. There is a slight drop in viability of samples cultured for 24 hours compared to pre-freeze and post-exposure samples, but this is attributed to the stress of the freezing process rather than to DMSO toxicity, as cells exposed to DMSO for longer do not show a larger decrease in viability. These results are reflected in the recovery results, which show no significant loss over the 4 hour hold period, but a lower recovery in samples cultured for 24 hours compared to pre-freeze and post-exposure samples.

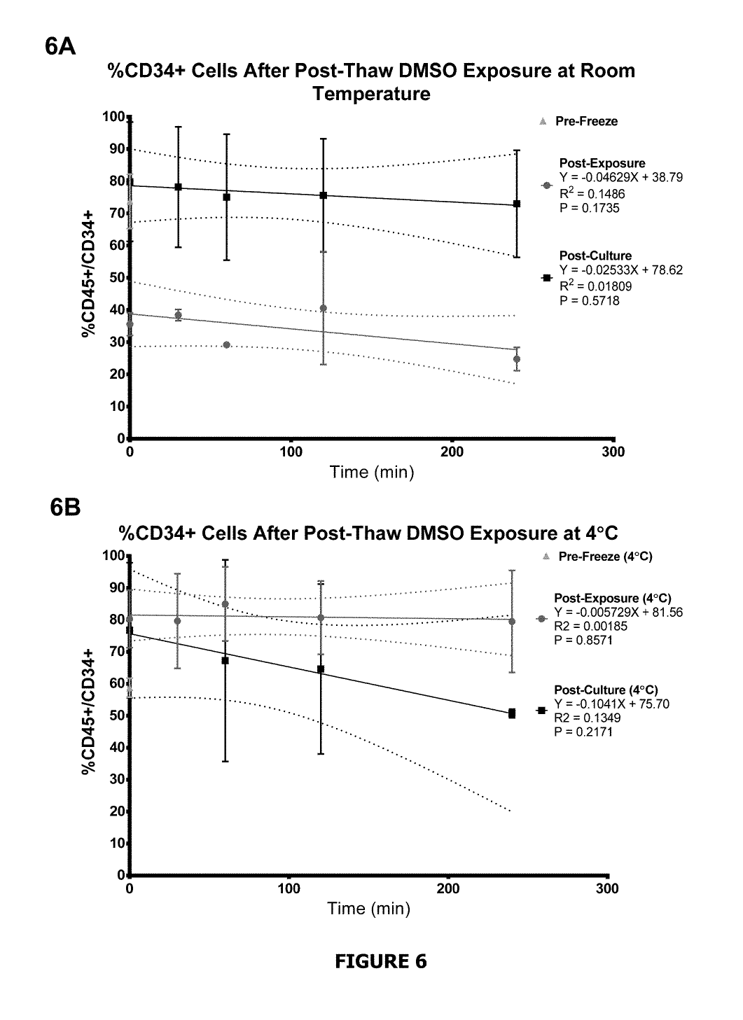

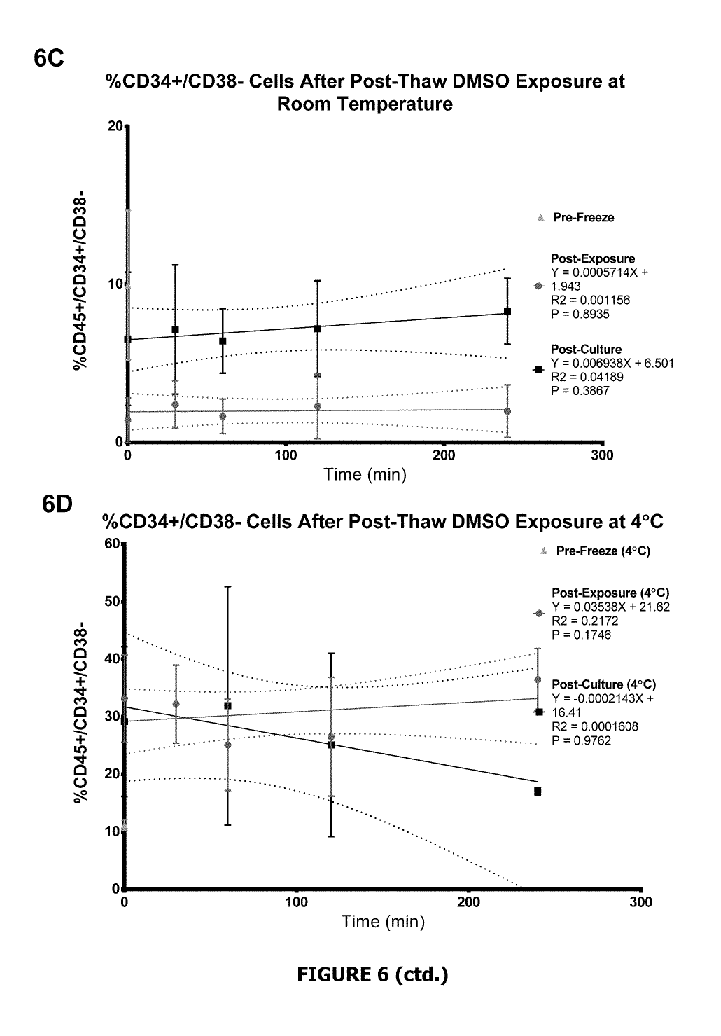

FIG. 6 shows that there is no significant decrease in % CD34+ cells following exposure to 5% DMSO for up to 4 hours, for cells held at 4° C. or at room temperature. At 20° C., there is a significant drop in CD34+ cells immediately post-exposure compared to pre-freeze levels, but after 24 hours of culture the % CD34+ cells increases to pre-freeze levels, suggesting that the freezing process can affect CD34 expression but that the cells can recover. This is not thought to be a result of DMSO toxicity, as cells exposed for longer do not show a larger decrease in CD34 expression. This pattern is not seen for samples held at 4° C., but this may in part reflect donor variability. A similar pattern is seen for the % CD34+/CD38− cells held at 20° C., which decrease significantly (p<0.0001) immediately after freeze/thaw but then recover to close to pre-freeze levels following 24 hours of normal cell culture. Again, this pattern is not seen for samples held at 4° C.

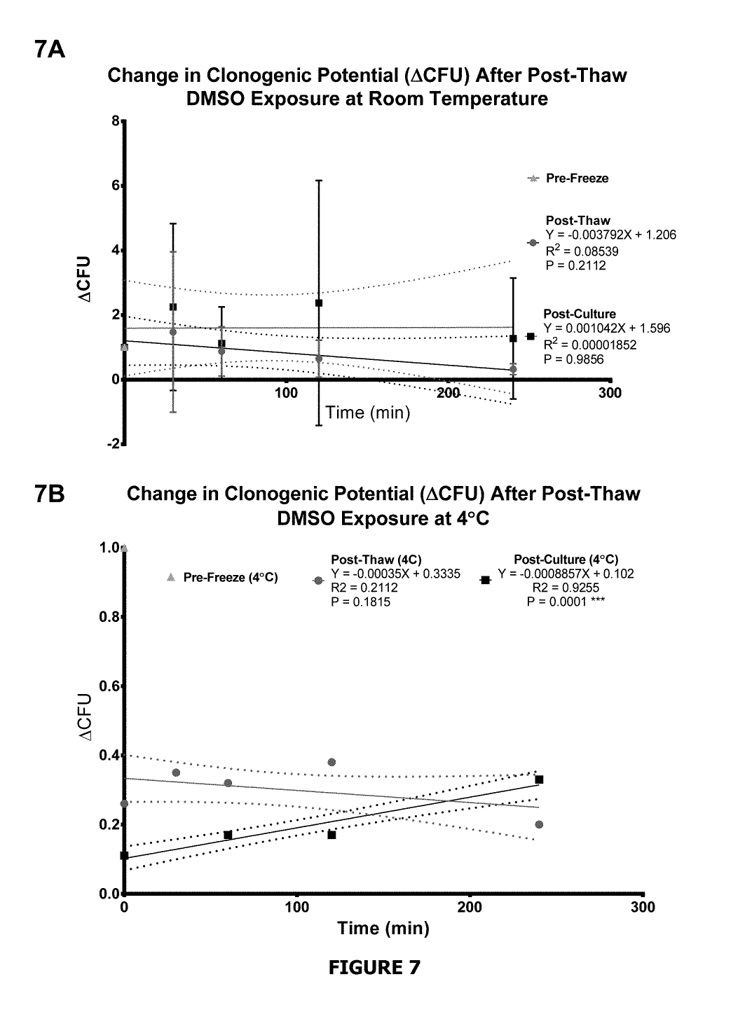

FIG. 7 shows that there is no significant decrease in clonogenic potential of cells following exposure to 5% DMSO, either immediately after exposure or after 24 hours of culture, at either room temperature or 4° C. There is a decrease in clonogenic potential from pre-freeze to post-thaw; however this is likely to be a result of the freeze-thaw process and not DMSO toxicity, as samples exposed to DMSO for longer do not show a greater decrease in clonogenic potential. Slightly lower clonogenic potential is seen in samples held at 4° C., although this might reflect variability due to different bone marrow donors.

### CONCLUSIONS

These studies demonstrated significantly higher viability (p=0.0086) in samples cryopreserved in 5% DMSO, compared to 10% DMSO, with no significant difference in recovery, % CD34+ cells, % CD34+CD38− cells, or clonogenic potential between the two conditions. Stability experiments demonstrated no adverse effects of 5% DMSO on CD34+ HSCs for up to 4 hours, both pre-freeze and post-thaw.

### Example 3: Long-Term Stability Assessment Studies

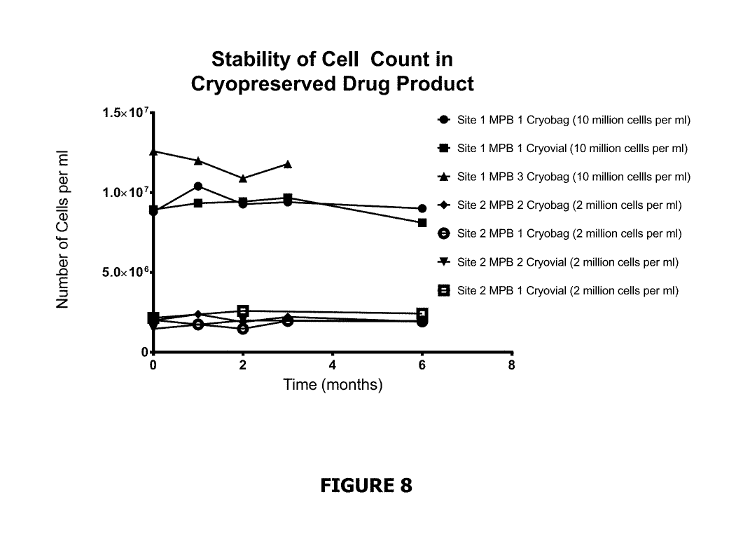

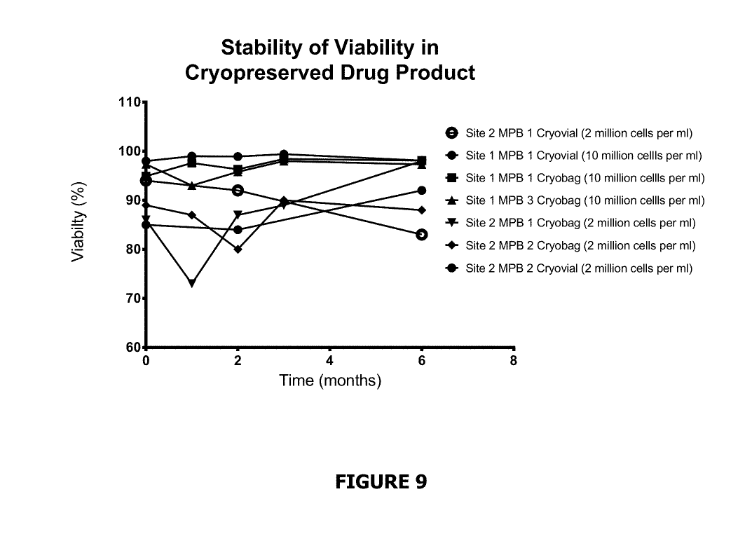

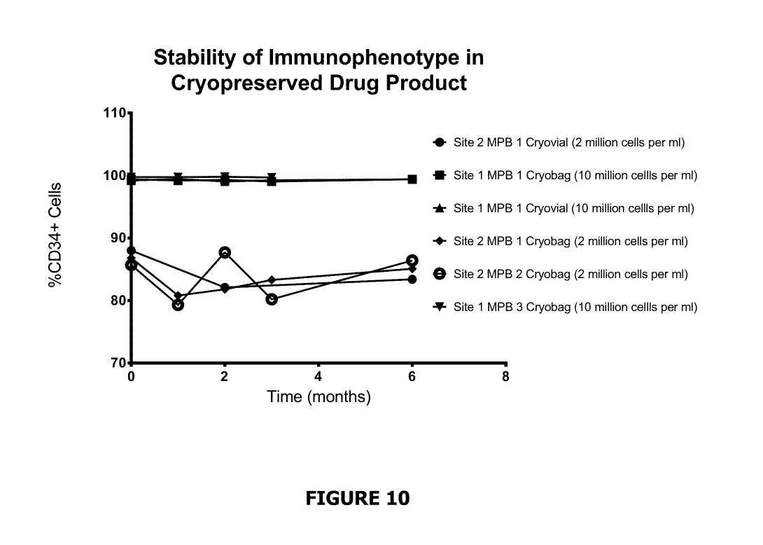

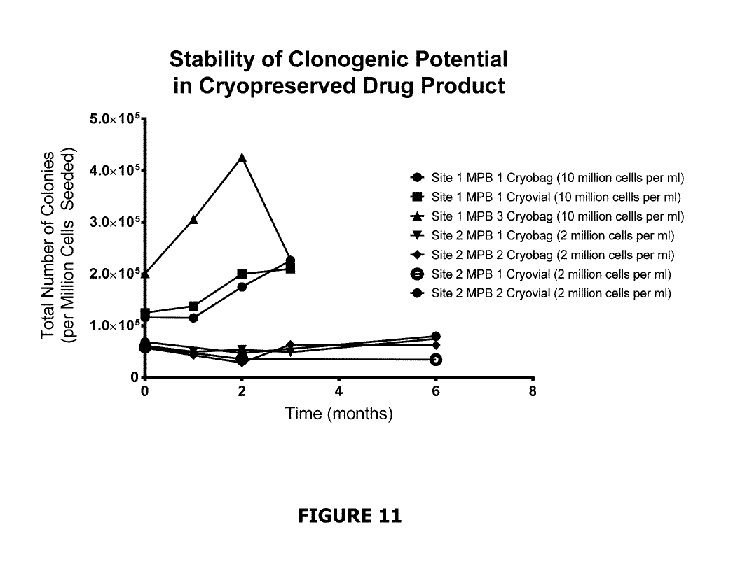

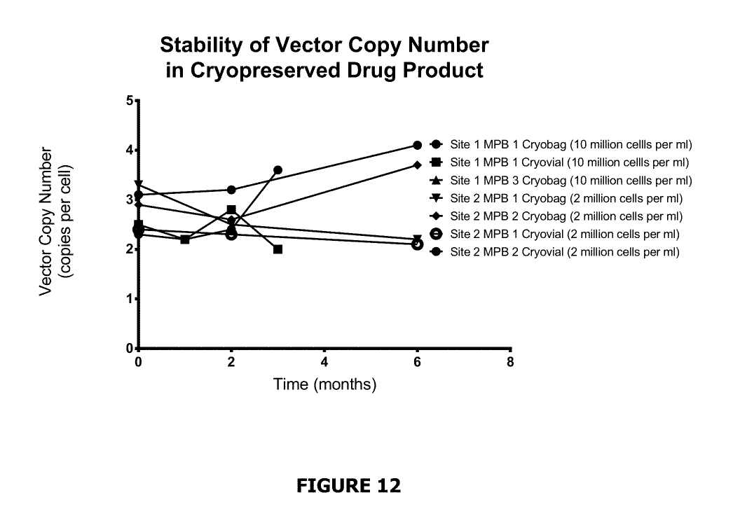

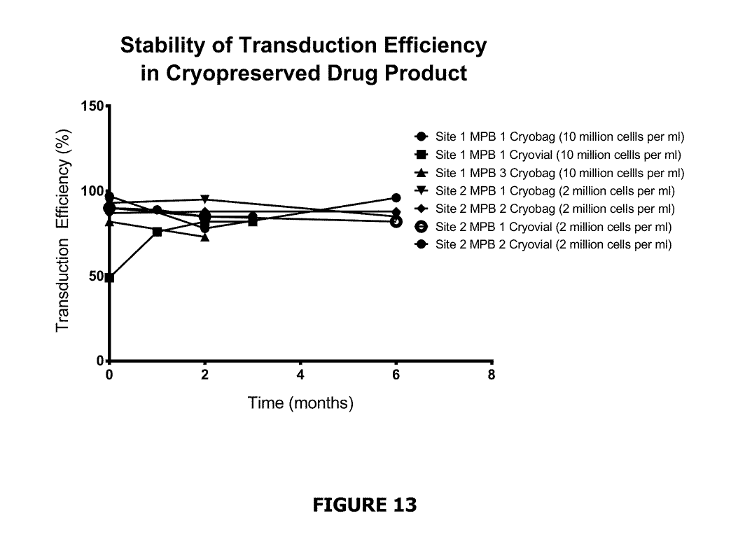

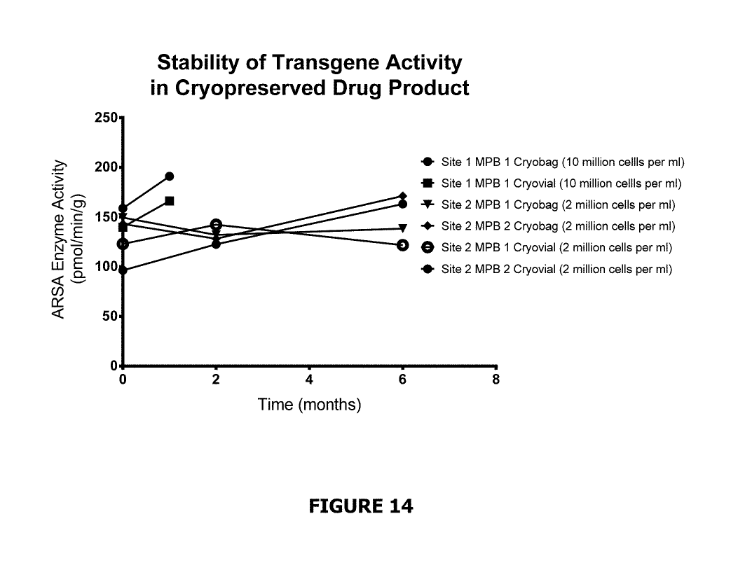

FIGS. 8 to 14 show results obtained as part of a study assessing the stability of the cryopreserved drug product in the formulation discussed herein. CD34+ cells isolated from mobilised peripheral blood were transduced with a viral vector containing the ARSA gene (used for the treatment of MLD). Cells from multiple healthy donor batches were frozen at 2 sites (one in the EU and one in the US), at 2 different concentrations (2 million per ml and 100 million per ml), and in 2 different containers (cryobags and cryovials). The cells were thawed at 0, 1, 2 and 6 months, and assessed for cell number, cell viability, CD34 expression, stem cell potential, vector copy number, transduction efficiency and ARSA activity. This was done using well-established analytical methods: cell number and viability was performed by counting using the trypan blue exclusion assay; stem cell potential and transduction efficiency was performed using the colony-forming unit (CFU) assay; CD34 expression was assessed by flow cytometry; vector copy number was performed using a PCR-based method; and ARSA activity was performed using a commercially available assay kit.

The data was analysed for linear regression to determine whether there was a significant change in any of these parameters over the time period tested. Results showed that there was no significant change, demonstrating the stability of the cells in the formulation for up to 6 months.

It will be understood that the embodiments described herein may be applied to all aspects of the invention. Furthermore, all publications, including but not limited to patents and patent applications, cited in this specification are herein incorporated by reference as though fully set forth.

1. A composition comprising a transduced haematopoietic cell in a cryoprotective formulation, wherein the cryoprotective formulation comprises about 5% by volume of dimethyl sulfoxide (DMSO) and about 7% weight by volume of human serum albumin (HSA).

2. The composition of claim 1, wherein the haematopoietic cell is a haematopoietic stem cell.

3. The composition of claim 2, wherein the haematopoietic stem cell is selected from a CD34+ haematopoietic stem cell or a CD34+CD38− haematopoietic stem cell.

4. The composition of claim 1, wherein the haematopoietic cell is allogeneic or autologous.

5. The composition of claim 1, wherein the haematopoietic cell is transduced with a lentiviral vector.

6. The composition of claim 1, wherein the haematopoietic cell contains a transgene encoding arylsulfatase A or a fragment or derivative thereof.

7. The composition of claim 1, which is formulated in 0.9% saline solution.

8. A method for preserving the viability of transduced haematopoietic cell, the method comprising:
(a) obtaining a plurality of transduced haematopoietic cells;
(b) suspending the transduced haematopoietic cells in a cryoprotective medium comprising about 5% by volume of dimethyl sulfoxide (DMSO) and about 7% weight by volume of human serum albumin (HSA), to form a suspension; and
(c) freezing the suspension.

9. The method of claim 8, wherein step (a) comprises: (i) obtaining a plurality of haematopoietic cells; and (ii) transducing the haematopoietic cells with a viral vector.

10. The method of claim 8, wherein the haematopoietic cells are obtained from the patient or a donor.

11. The method of claim 8, wherein the haematopoietic cells are transduced with a lentiviral vector.

12. The method of claim 8, wherein the cryoprotective medium is formulated in 0.9% saline solution.

13. The method of claim 8, wherein the suspension is frozen in step (c) with a controlled rate freezer.

14. The method of claim 8, wherein the suspension is frozen in step (c) at a temperature from about −200° C. to a temperature of about −35° C.

15. The method of claim 14, wherein the suspension is frozen in step (c) at a temperature of about −80° C.

16. The method of claim 8, wherein the transduced haematopoietic cells are frozen at a cell concentration of at least about 1×10⁶/ml.

17. The method of claim 8, additionally comprising: (d) thawing the frozen suspension.

18. The method of claim 17, additionally comprising: (e) administering the thawed suspension to a patient.

19. A frozen suspension obtained by the method of claim 8.

20. A thawed suspension obtained by the method of claim 17.
